(19) United States
(12) Patent Application Publication
(10) Pub. No.: US 2006/0113774 A1
(43) Pub. Date: Jun. 1, 2006

(54) Airbag system for steering wheel

(75) Inventors: Osamu Hirose, Nishikasugai-gun (JP); Hitoshi Iida, Nishikasugai-gun (JP); Motoi Isomura, Nishikasugai-gun (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD, Aichi-ken (JP)

(21) Appl. No.: 11/284,087

(22) Filed: Nov. 22, 2005

(30) Foreign Application Priority Data
Nov. 26, 2004 (JP) 2004-342238

(51) Int. Cl. B60R 21/203; B60R 21/23

(52) U.S. Cl. 280/731; 280/728.2; 280/743.2

(57) ABSTRACT

An airbag system for a steering wheel according to the present invention, an airbag is folded through a first step and a second step after the airbag is unfolded flatly with the driver side wall and the vehicle body side wall superimposed. In the first step, the right side region is folded to be mounted over a gas inlet, and then, roll-folding the left side region from its outer circumference toward the driver side wall, the left side region is superimposed by the folded part of the right side region. In the second step, in the airbag folded through the first step, at least the front side region located to the front side of the gas inlet is roll-folded from its front edge toward the vehicle body side wall.

The present application claims priority from Japanese Patent Application No. 2004-342238 of Hirose et al., filed on Nov. 26, 2004, the disclosure of which is hereby incorporated into the present application by reference.

### BACKGROUND OF THE INVENTION

1. Field of the Invention

The present invention relates to an airbag system for a steering wheel comprising an airbag that is folded and housed in a boss part of a steering wheel, which allows expansion gas to flow therein so that the airbag is unfolded and expanded.

2. Description of the Related Art

Conventionally, the airbag system for a steering wheel has the configurations disclosed in JP-A-6-144136 and JP-A-7-89402. In these airbag systems, an airbag is folded through first and second steps, then the folded airbag is housed. In the first step, the airbag is folded so that the roughly circular vehicle body side wall and the roughly circular driver side wall extend flatly and overlap. Then, the regions at the right and left edges are folded along lines roughly in the vehicle longitudinal direction so as to bring these regions close to the gas inlet that is arranged near the center of the vehicle body side wall. In the second step, the front and rear portions of the regions folded in the first step are further folded along folded lines in the approximate vehicle transverse direction so as to bring these portions close to the gas inlet side.

In addition, as shown in U.S. Pat. No. 5,275,435, as the airbag system, the airbag is folded and housed as follows. In the first step of folding, in the airbag, the one of the region to the left and right sides of a gas inlet is folded back to the other region so as to bring its edge close to the edge of the other region, and then, the other region is folded together with the one of the region. In this airbag system, when the airbag is unfolded near a passenger, the expanded other region pushes the passenger near the airbag to the left or right side. In other words, before the airbag expands thickly rearward against the passenger nearby, this passenger is moved to the left or right side so as to remove him or her from the area of the airbag that expands greatly rearward, thus reducing damage to the passenger.

However, according to the airbag system described in the above publication, when the first step of folding is completed, the outer circumference portion of the one of the region is not completely wrapped up and covered by the other region. As a result, the outer circumference portion of the one of the region is easily exposed. Therefore, at the early stage of expansion of the airbag, when the other region expands, sometimes the one of the region is exposed and this one of the region also projects from the exposed part and expands. In this case, it is difficult for the region which should expand so as to move the passenger to the side to expand, and as a result, this region cannot forcefully move the passenger to the left or right side so as to remove him or her from the area of the airbag that expands greatly rearward. In addition, when the driver is near a steering wheel, sometime the driver's head is located near the region at the upper side of a ring part, so that it is necessary to consider the damage to the driver's head. Therefore, it is difficult to directly apply the above-described configuration for the airbag system of the steering wheel.

### SUMMARY OF THE INVENTION

The object of the present invention is to provide an airbag system for a steering wheel capable of unfolding and expanding an airbag, which suppresses the force applied to the driver near the steering wheel.

The object of the present invention can be achieved by an airbag system that is mounted on a steering wheel, wherein the steering wheel comprises a ring part, which is formed in an approximate annular shape and is held by the driver upon operation of the automobile; a boss part, which is arranged on the center of the steering wheel and is coupled to a steering shaft; and a spoke part, which is arranged so as to connect the ring part with the boss part; the spoke part is provided so as to be able to secure a space for viewing a meter located at the inner circumferential side of the ring part; the airbag system for the steering wheel comprises an airbag that is folded and housed in the boss part, the airbag allows the expansion gas to flow therein so that the airbag is unfolded and expanded to protect the driver and cover the upper side of the steering wheel; and the airbag is configured in such a manner that the circumference of the roughly circular vehicle body side wall, which is remains at the steering wheel upon completion of expansion and has a gas inlet for allowing the expansion gas to flow in the vicinity of the center, and the circumference of the driver side wall, which contacts the driver upon completion of expansion and whose outer shape is approximately the same as that of the vehicle body side wall are coupled with each other; wherein the airbag is folded and housed through at least two steps, namely, a first step and a second step after the airbag is unfolded flatly with the driver side wall and the vehicle body side wall overlapping; in the first step, in order to reduce the width in the right and left direction of the airbag, the regions at the opposite edges in the right and left (transverse) direction are folded along folded lines extending roughly in the vehicle longitudinal direction, so that the edges are brought close to the gas inlet; and in the second step, in order to reduce the width in the vehicle longitudinal direction of the airbag that is folded in the first step, the regions at the opposite edges in the longitudinal direction are folded along lines extending in the approximate transverse direction, so that the edges are brought close to the gas inlet side; wherein, according to the first step, the airbag is folded in such a manner that, after the airbag is unfolded flatly with the driver side wall and the vehicle body side wall overlapping, the one of the region to the left or the right of the gas inlet is folded so as to reduce the width in the transverse direction and is put over the gas inlet; and then, the outer circumference in the transverse direction of the other region is rolled up facing the driver side wall and is superimposed on the upper side of the folded one of the region; and according to the second step, the airbag is folded in such a manner that, when bringing the front side region and the rear side region of the gas inlet close to the gas inlet side, at least the front side region located to the front side of the gas inlet is rolled up its front edge toward the vehicle body side wall.

According to the airbag system for the steering wheel of the present invention, at the early stage of expansion of the airbag, when the driver is near the steering wheel, the airbag is unfolded and expands as follows. At first, when the airbag undoes the folding made in the second step to be unfolded, the front side region located to the front side of the gas inlet that is rolled up is unrolled so as to enter the space for viewing the meters formed between the boss part and the ring part thereby interfering with the driver. Therefore, the upper face of the unfolded front side region is restrained by the ring part. As a result, the front side region of the airbag is prevented from expanding so as to project toward the head side of the driver.

Then, at approximately the same time as the unfolding of the region folded by the second step, the airbag is expands so as to unfold the region folded by the first step. In this case, in the airbag system for the steering wheel according to the present invention, the upper side folded portion (folded other region) in the first step is roll-folded from the outer circumference of the wall toward the driver side wall (hereinafter, referred to as “internally rolled”). Therefore, when the folded other region of the first step contacts the driver near the steering wheel, since the contact other region is internally rolled, the friction force generated due to the contact with the driver inhibits release of folding of the internally rolled region (the other region). Thus, the other region does not expand so as to unfold, but rather the folded one of the region arranged below the internally rolled region unfolds while expanding due to the expansion gas flowing therein. In other words, in the airbag system for the steering wheel of the present invention, when the fold made in the first step is unfolded, when the driver is near the steering wheel, at first, the one of the region in the transverse direction of the gas inlet only expands significantly with the expansion gas flowing therein. Then, in accordance with the expansion of this one of the region, the driver near the steering wheel is pushed to one side in the transverse direction (viewed from the airbag side, at the driver is pushed to the other side in the first step). Therefore, the driver moves to the right or left so that the driver is removed from the greatest expansion area of the airbag. After the driver moves, unfolding the internal roll folded region (the other region) allows the expansion gas to flow therein. Further, the front side region located to the front side of the gas inlet with its upper side suppressed by the ring part also projects toward the upper side of the ring part in accordance with the expansion of the other regions. As a result, the airbag may complete the rearward expansion and cover the upper face of the steering wheel.

In other words, according to the airbag system for the steering wheel of the present invention, when the driver is near the steering wheel, the airbag may expand as follows. At the early stage of expansion, one side in the transverse direction, right or left, of the airbag expands while being suppressed the front side region from projecting to the driver as much as possible because the ring part catches on the front side region. Then, this one side region expanded in the transverse direction may move the driver, pushing him or her toward one side in the transverse direction, so that the driver is removed from the expansion area of the airbag. After the driver moves so as to be removed from the expansion area of the airbag, the airbag is completely expanded, including the front side region to cover the upper surface of the steering wheel wholly. Therefore, it is possible to make the airbag expand without strongly pushing the driver near the steering wheel. As a result, for example, it is possible to make the airbag which prevents the driver from being strongly pushed, after the airbag projects between the driver's neck and the driver's jaw to fasten the jaw.

Accordingly, in the airbag system for the steering wheel of the present invention, the airbag can be unfolded and expand with less pushing of the driver near the steering wheel.

In addition, according to the airbag system configured as described above, it is preferable that, according to the first step, the airbag is folded in such a manner that the vehicle outside region to the left or right of the gas inlet is folded so as to reduce the width in the transverse direction and is put on the upper side of the gas inlet; and then, the vehicle inside region is rolled from the portion of the outer circumference in the transverse direction toward the driver side wall and be superimposed on the upper side of the folded vehicle outside region.

If the airbag is folded down as described above, in the case of releasing the folds of the first step when the airbag expands and the driver is near the steering wheel, only the vehicle outside region transverse to the gas inlet expands significantly with the expansion gas flowing therein. Further, in accordance with the expansion of this vehicle outside region, the driver near the steering wheel is pushed toward the inside of the vehicle. In other words, this configuration of the airbag is preferable because the driver near the steering wheel can be moved to the inside of the vehicle.

Further, according to the first step, the airbag may be folded in such a manner that, after the airbag is laid out flatly with the driver side wall and the vehicle body side wall placed each other, one of the transverse regions to the gas inlet is folded along a line in the roughly vehicle longitudinal direction at a position in the vicinity of the gas inlet, toward the driver side wall so that its outer circumference comes close to the outer circumference of the other region; and then, at the upper and lower side and the outer circumferential end side of the one of the region are wrapped by the other region, and the other region at the other side is folded so as to bring its outer circumference close to the gas inlet together with the one of the region superimposed on the other region, the folded other region on the upper side of the gas inlet;
and according to the second step, when the regions to the front and rear of the gas inlet are folded to close to the gas inlet, and at least the front side region located to the front side of the gas inlet is rolled up toward the vehicle body side wall.

Even in the case that the airbag folded in this way is used, upon unfolding the fold of the first step, unfolding at one of the region is prevented and only the other region is unfolded as the expansion gas flows in and expands the airbag. Particularly, in the above-described folded airbag, the one of the region is not unfolded till the vicinity of the outer circumference of the other region is unfolded, so that it is possible to make an airbag which unfolds and expands the other region before the one of the region without fail, because the upper and lower sides and the transverse end side of the outer circumference of the one of the region are wrapped by the other region, then the other region is folded together with the one of the region, kept its transverse end side wrapped. Therefore, with expansion of the other region in which the expansion gas flows, the driver near the steering wheel is pushed to one side in the transverse direction (viewed from the airbag side, pushed to the one side in the first step), and this makes the driver to move to one side in the transverse direction so that he or she is removed from the greatest expansion area of the airbag. Then, after the driver is moved, when the other region of the airbag is completely unfolded, the one of the region of the airbag expands with the expansion gas flowing therein. Further, the front side region located to the front side of the gas inlet projects above the ring part after expansion of the other region. As a result, the upward expansion is completed with the airbag covering the upper surface of the entire steering wheel.

In other words, when the driver is near the steering wheel, even if the folded airbag as described above is used, at the early stage of expansion, one side in the transverse direction of the airbag expands while being suppressed the front side region from projecting toward the driver as much as possible because the ring part catches on the front side region. Then, the one side region may move the driver, pushing him or her toward one side in the transverse direction, so that the driver is removed from the expansion area of the airbag. After the driver moves so as to be removed from the expansion area of the airbag, the upward expansion is completed with the airbag covering the upper surface of the entire steering wheel including the front side region. Therefore, it is possible to make an airbag which expands without strongly pushing against the driver near the steering wheel. As a result, for example, this airbag prevents the driver from being exposed to strong pressure, while the airbag is protruded between the driver's neck and the driver's jaw to immobilize the jaw.

Accordingly, even if the folded airbag as described above is used, the airbag can be unfolded and expand with the pressure applied to the driver near the steering wheel reduced.

Moreover, according to the airbag system configured as described above, it is preferable that in the first step the airbag is folded in such a manner that, after folding the one of the region of the transverse directional sides of the gas inlet toward the driver side wall, the outer circumference of the other region is folded back to be superimposed above the outer circumference of the one of the region so as to wrap the transverse end side of the outer circumference of the one of the region by the outer circumference of the other region; and then, with the one of the region superimposed on the other region, the other region is roll-folded from the folded back edge toward the driver side wall to put on the upper side of the gas inlet.

According to the airbag system configured as described above, the furthest edge of the outer circumference portion at the one of the region is held down by the furthest edge of the outer circumference portion of the other region. Therefore, when the airbag is unfolded and expands, unfolding and expansion of the one of the region can be suppressed as much as possible. Then, conversely, it becomes possible to expand outward most of the other region before the outer circumference portion is expanded. Therefore, this expanded other region can push the driver near the steering wheel far to one side in the transverse direction.

Moreover, according to the airbag system configured as described above, it is preferable that in the first step the airbag is folded in such a manner that the vehicle interior region at the side of the gas inlet is folded over the driver side wall in the portion of the vehicle exterior region, along a line in the approximate vehicle longitudinal direction at in the vicinity of the gas inlet, so as to bring the outer circumference of the vehicle interior region to the outer circumference of the vehicle exterior region; and then, the upper and lower opposite sides and the outer circumference end side of the vehicle interior region are wrapped by the vehicle exterior region; with the vehicle interior region superimposed to the vehicle exterior region, the vehicle exterior region is folded so as to bring the portion of its outer circumference in the transverse direction close to the gas inlet and thus the vehicle exterior region is put on the upper side of the gas inlet.

If the airbag is folded as described above, upon unfolding of the fold made in the first step, when the airbag expands with the driver near the steering wheel, the airbag can be made to unfold and expand the vehicle exterior region in the transverse direction of the gas inlet before the vehicle interior region without fail. Therefore, in accordance with expansion of the vehicle exterior region in which the expansion gas flows, the driver near the steering wheel is pushed to the inside of the vehicle. In other words, this airbag is preferable because the driver near the steering wheel can be moved to the inside of the vehicle.

### BRIEF DESCRIPTION OF THE DRAWINGS

FIG. 1 is a plan view of a steering wheel in which an airbag system for a steering wheel as an embodiment according to the present invention is used.

FIG. 2 is a schematic sectional view of the steering wheel of the embodiment and corresponds to a II-II section of FIG. 1.

FIG. 3 is a plan view showing that the airbag used in the embodiment is unfolded.

FIG. 4 is a bottom view showing that the airbag of the embodiment is unfolded.

FIG. 5 is a schematic sectional view showing that the airbag of the embodiment is unfolded.

FIG. 6 is a schematic exploded perspective view showing constructional elements upon manufacture of the airbag of the embodiment.

FIGS. 7A to 7D are schematic diagrams showing folding steps of the airbag of the embodiment.

FIG. 8 is a schematic sectional view showing the early stage of expansion of the airbag in the airbag system of the embodiment.

FIG. 9 is a schematic sectional view showing the completion stage of expansion of the airbag in the airbag system of the embodiment.

FIG. 10 is a schematic diagram showing the expansion completion state of the airbag in the airbag system of the embodiment seen from the side of the steering wheel.

FIGS. 11A and 11B are schematic diagrams showing the expansion processes of the airbag when the driver is near the steering wheel in the airbag system of the embodiment.

FIGS. 12A to 12C are schematic diagrams showing expansion steps of the airbag when the driver is near the steering wheel in the airbag system of the embodiment.

FIGS. 13A and 13B are schematic diagrams showing expansion steps of the airbag after the step in FIG. 12C, toward the outside of the vehicle when the driver is near the steering wheel in the airbag system of the embodiment.

FIGS. 14A to 14E is schematic diagrams showing the other folding steps of the airbag used in the airbag system of the embodiment.

FIGS. 15A to 15C are schematic diagrams showing the expansion steps of the airbag when the driver is near the steering wheel in the airbag system using the airbag that is folded in the steps shown in FIGS. 14A to 14E.

FIGS. 16A and 16B are schematic diagrams showing the expansion steps of the airbag after the step in FIG. 15C when the driver is near the steering wheel in the airbag system using the airbag that is folded in the steps shown in FIGS. 14A to 14E.

FIGS. 17A to 17E are schematic diagrams showing still other folding steps of the airbag used in the airbag system of the embodiment.

### DETAILED DESCRIPTION OF THE INVENTION

Preferred embodiments of the present invention are now described below with reference to the accompanying drawings. However, the invention is not limited to the embodiments disclosed herein. All modifications within the appended claims and equivalents relative thereto are intended to be encompassed in the scope of the claims.

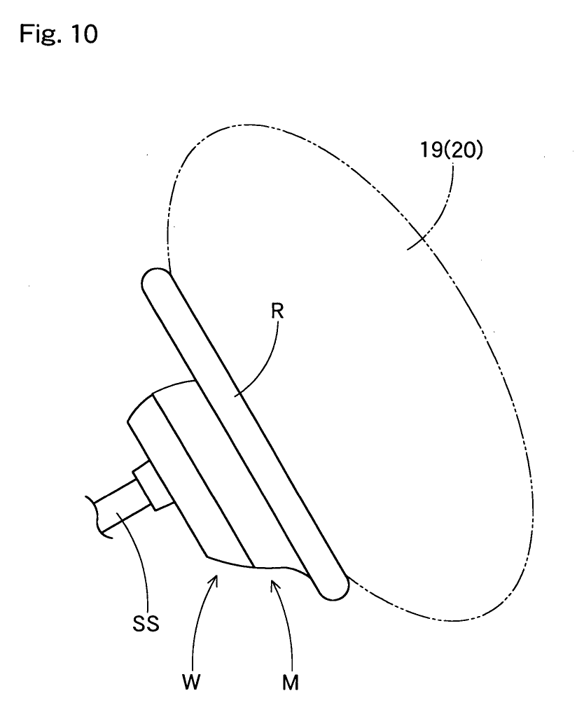

Hereinafter, an embodiment of the present invention will be described with reference to the drawings below. In the meantime, the longitudinal, vertical, and transverse directions in the embodiment are based on the case that a steering wheel W mounted in a vehicle is operated to go straight except for a special case. Specifically, the upper and lower direction along the axis of the steering shaft SS (refer to FIG. 10) to assemble a steering wheel W is defined as the vertical direction, the front to rear direction of the vehicle, which is perpendicular to the axis of the steering shaft SS, is defined as the longitudinal direction, and the right to left direction of the vehicle, which is perpendicular to the axis of the steering shaft SS, is defined as the transverse direction. These directions indicate the front and rear, the upper and lower, and the right and left directions, respectively.

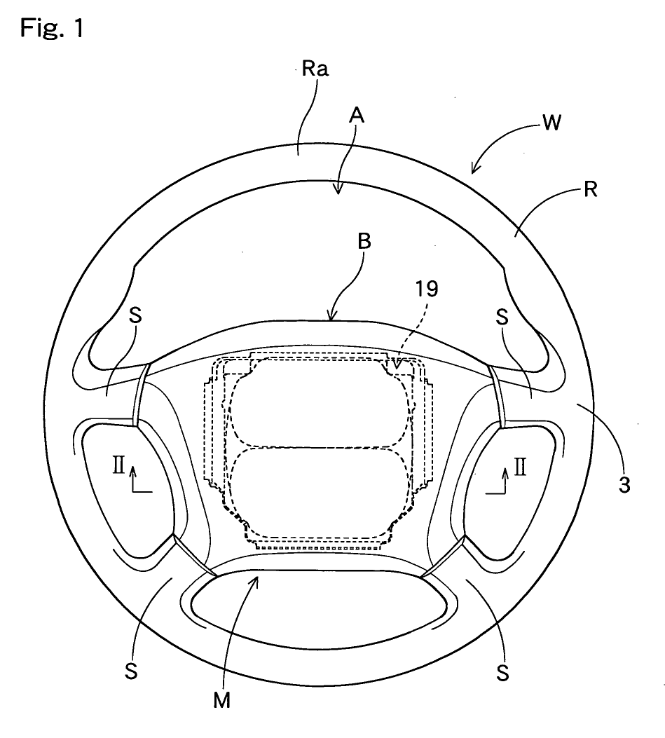

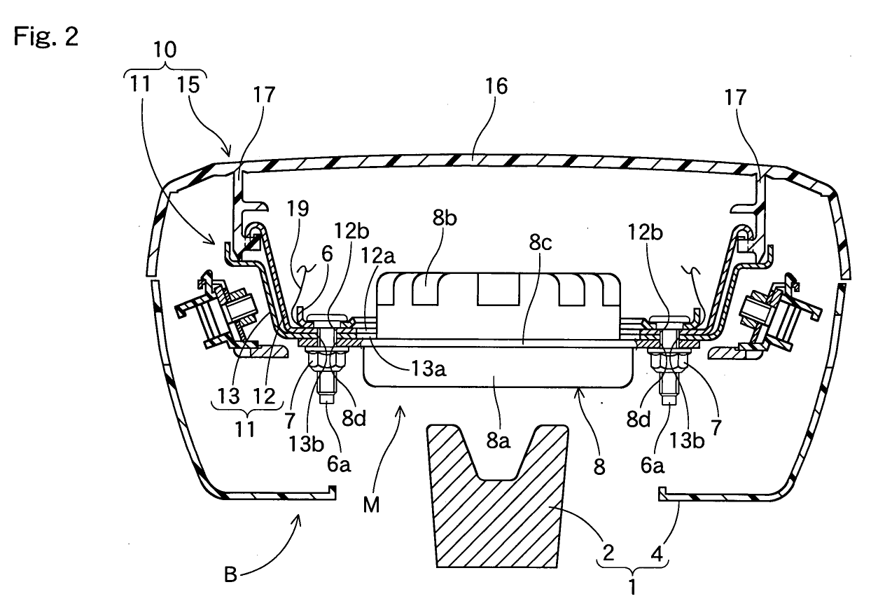

As shown in FIG. 1 and FIG. 2, the airbag system M for the steering wheel according to the present embodiment is arranged on the upper part of a boss part B at a center of the steering wheel W. The steering wheel W is provided with a ring part R formed in an approximate circle shape that is grasped upon operation, the boss B is arranged at the center of the steering wheel W to be coupled to a steering shaft SS (refer to FIG. 10), and spoke parts S (four spoke parts S are arranged in the present embodiment) are arranged so as to couple the ring part R and the boss part B. In front of the steering wheel W mounted on the vehicle, a meter is arranged. The spoke parts S are arranged so as to be able to secure a space A for viewing the meter formed by a space surrounded by the inner circumferential of the ring part R upon mounting on the vehicle. In addition, the steering wheel W constructional elements are the airbag system M and the steering wheel main body 1.

The steering wheel main body 1 is provided with a core metal 2 made of an aluminum base alloy or the like, a cover layer 3 made of a synthetic resin, and a lower cover 4 made of synthetic resin, to be arranged on the lower part of the boss part B. The core metal 2 is provided so as to couple the ring part R, the boss part B, and the spoke part S. The cover layer 3 covers the core metal 2 arranged on the ring part R and the core metal 2 of the portion of each spoke S close to the ring part R.

As shown in FIG. 2, the airbag system M is provided with a folded airbag 19, an inflator 8 for supplying the expansion gas to the airbag 19, and a case 10, respectively. The case 10 is a member covering the folded airbag 19 and holding the airbag 19 and the inflator 8.

The inflator 8 is provided with a main body 8a formed to be an approximate circular cylinder, and a flange part 8c formed to be an approximate square, arranged so as to project from the outer circumferential surface of the main body 8a. On the upper end side of the main body 8a, gas discharging ports 8b to discharge the expansion gas are located. On the flange part 8c, insertion holes 8d are formed, through which bolts 6a are projected from a retainer 6 (to be described later).

The retainer 6 is made of an approximate square annular sheet metal, and is provided with four bolts 6a projecting downward at the four corners. This retainer 6 holds a peripheral border of a gas inlet 22 (to be described later) of the airbag 19 so as to attach the airbag 19 to a bag holder 11 of the case 10. The bolts 6a of the retainer 6 project from the flange part 8c of the inflator 8 through the peripheral border of the gas inlet 22 and the bag holder 11 to be described later and then, the bolts 6a are fastened by nuts 7.

The case 10 includes the bag holder 11 made of a sheet metal and a pad 15 made of a synthetic resin, to be an airbag cover.

The bag holder 11 includes a holder plate 12 formed in to be an approximately rectangular parallel piped shape with its upper side opened and a back-up plate 13. The back-up plate 13 is a member to clip the pad 15 together with the holder plate 12. On respective plates 12 and 13, insertion holes 12a and 13a, through which the main body 8a of the inflator 8 is inserted from its lower side, are provided, respectively. Around the insertion holes 12a and 13a on respective plates 12 and 13, mounting holes 12b and 13b are formed, through which each bolt 6a of the retainer 6 is inserted. In addition, the back-up plate 13 is provided with a bracket (not illustrated) that is coupled to the core metal 2 of the steering wheel main body 1.

The pad 15 is provided with a cover part 16 and a side wall part 17. The cover part 16 is a member to cover the upper side of the boss part B. The side wall part 17 projects downward from the lower surface of the peripheral border of the cover part 16 in an approximate square tubular shape. On the region encircled by the side wall part 17 of the cover part 16, two doors (reference numeral omitted) are provided opening toward the longitudinal directional sides of the steering wheel W, upon the expansion of the airbag 19. Around the doors, a thin breakaway line (reference numeral omitted) to smoothly open the doors when pressed by the airbag 19 is formed. The side wall part 17 is held at its lower portion by the bag holder 11, sandwiched between the holder plate 12 and back-up plate 13.

Further, according to the present embodiment, the lower surface side of the folded airbag 19 is restrained by the holder plate 12 of the bag holder 11 and the main body 8a of the inflator 8. The upper face side of the folded airbag 19 is restrained by the cover part 16 and the side wall part 17 of the pad 15.

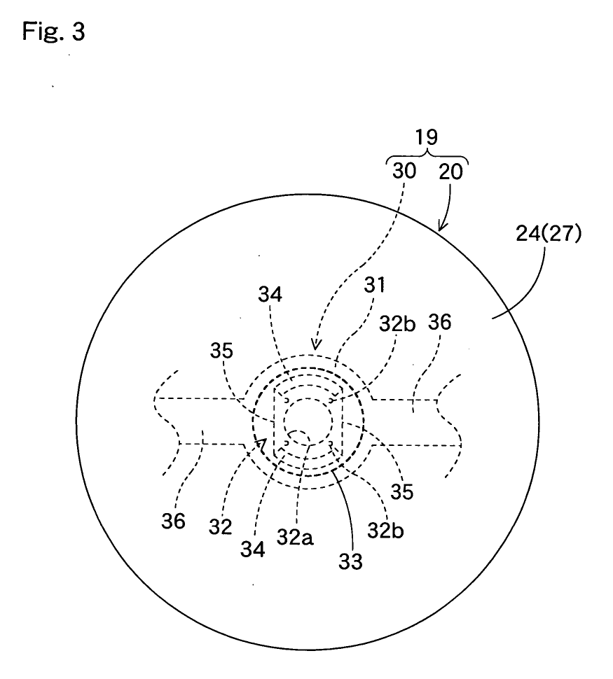

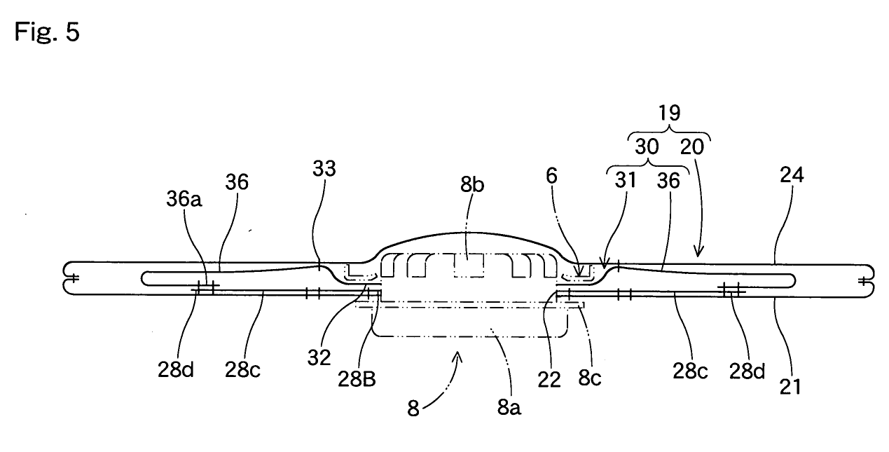

As shown in FIGS. 3 to 5, the airbag 19 is provided with a bag main body 20 formed in a bag, which expands by allowing the expansion gas to flow therein, and a flow regulating cloth 30. The flow regulating cloth 30 is a member to control the flowing direction of the expansion gas into the bag main body 20. The bag main body 20 is made of flexible woven fabric of polyester, polyamide or the like. The bag main body 20 is provided with a vehicle body side wall 21, arranged on the steering wheel W side upon completion of expansion, and a driver side wall 24, which faces the driver MD upon completion of expansion. At the center of the vehicle body side wall 21, the gas inlet 22 is formed as a circular opening. The gas inlet 22 is a member which allows the inflator main body 8a to be inserted from the lower side of the airbag and thus allows the expansion gas discharged from the gas discharging ports 8b of the inflator 8 to flow therein. In addition, on the peripheral border of the gas inlet 22, four mounting holes 23 are formed, through which each bolt 6a formed on the retainer 6 is inserted. In FIGS. 5, 9, 12, and 13, the illustration of the bag holder 11 to be arranged between the peripheral border of the gas inlet 22 of the airbag 19 and the flange part 8c of the inflator 8 is omitted.

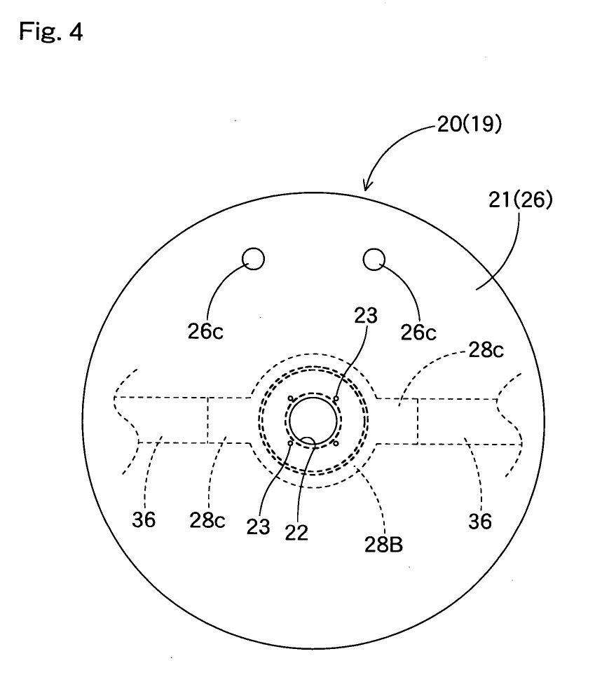

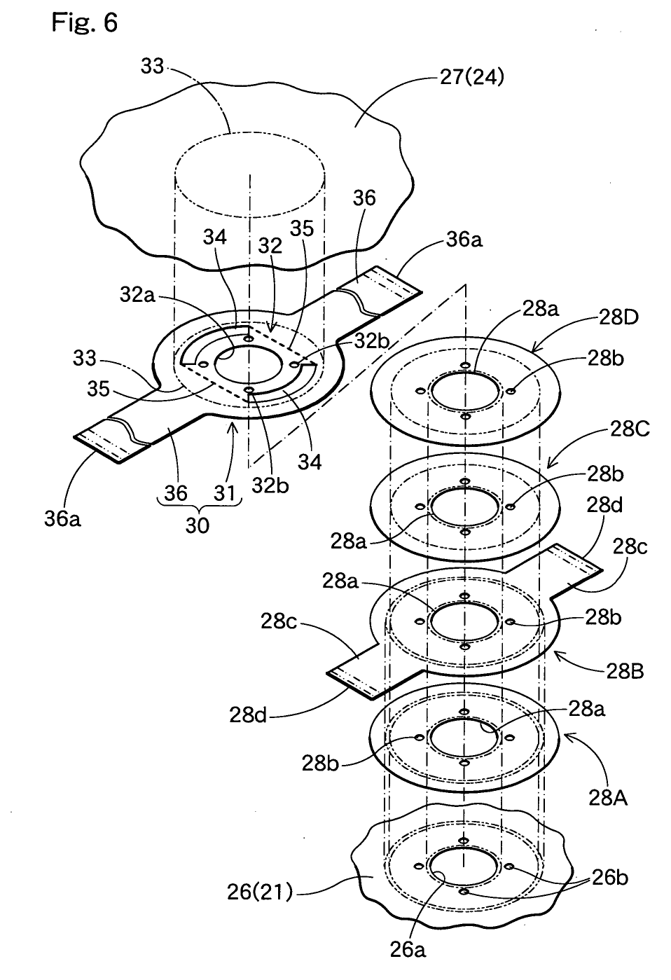

In addition, according to the present embodiment, as shown in FIG. 6, the bag main body 20 is configured by a circular vehicle body side base cloth 26, a circular driver side base cloth 27, and reinforcing cloths 28A, 28B, 28C, and 28D. The vehicle body side base cloth 26 configures the vehicle body side wall 21, and is provided at its center with a circular opening 26a configuring the gas inlet 22. The vehicle body side base cloth 26 is provided with four mounting holes 26b configuring the mounting holes 23 at the peripheral border of the opening 26a. In addition, as shown in FIG. 4, on the vehicle body side base cloth 26, vent holes 26c are formed. The driver side base cloth 27 configures the driver side wall 24, and its outer shape is identical with that of the vehicle body side base cloth 26. The reinforcing cloths 28A, 28B, 28C, and 28D are provided so as to reinforce the strength of the peripheral border of the gas inlet 22. The number of these reinforcing cloths 28A, 28B, 28C, and 28D can be appropriately varied in accordance with the output of the inflator 8. On respective reinforcing cloths 28A, 28B, 28C, and 28D, an opening 28a corresponding to the gas inlet 22 and mounting holes 28b corresponding to the mounting holes 23 are formed. In addition, on the reinforcing cloth 28B, band-like coupling parts 28c are formed so as to be elongated from the peripheral border to the opposite transverse directional sides so as to be symmetric. These coupling parts 28c are the members to be coupled to tether parts 36 (to be described later) of the flow regulating cloth 30.

The flow regulating cloth 30 is made of a woven fabric having flexibility, made from a polyamide thread or a polyester thread or the like, as the bag main body 20. As shown in FIGS. 3 and 6, the flow regulating cloth 30 comprises an approximately circular flow regulating cloth main body 31 and two band-like tether parts 36 extending from the peripheral border of the flow regulating cloth main body 31. The flow regulating cloth main body 31 is coupled to the driver side wall 24 and the vehicle body side wall 21 at the vicinity of the gas inlet 22. In other words, the flow regulating cloth main body 31 couples the driver side wall 24 and the vehicle body side wall 21 at the vicinity of the gas inlet 22. Then, the flow regulating cloth main body 31 is configured so as to break the coupling between the driver side wall 24 and the vehicle body side wall 21 at the vicinity of the gas inlet 22 when the inner pressure of the bag main body 20 reaches a certain pressure.

Specifically, the outer circumference portion of the flow regulating cloth main body 31 is sewed at the center of the driver side wall 24 on the driver side coupling part (a sewed region) 33 to be an annular shaped. Then, in the flow regulating cloth main body 31, a vehicle body side coupling part 32 is arranged inside the driver side coupling part 33. This vehicle body side coupling part 32 is coupled at the vicinity of the gas inlet 22 of the vehicle body side wall 21 using the retainer 6. In addition, on the vehicle body side coupling part 32, a circular opening 32a is formed, which can insert the inflator main body 8a in a position corresponding to the gas inlet 22. Further, on the vehicle body side coupling part 32, four mounting holes 32b are formed corresponding to the mounting holes 23, in which can be inserted the bolts 6a of the retainer 6. In other words, according to the present embodiment, arranging the retainer 6 above the vehicle body side coupling part 32, the vehicle body side coupling part 32 is fixed to the bag holder 11 together with the vehicle body side wall 21, by the retainer 6. Then, the flow regulating cloth main body 31, whose circumference portion is coupled to the vicinity of the center of the driver side wall 24, is coupled to the vehicle body side wall 21 at the vicinity of the gas inlet 22.

In addition, gas outlets 34 are formed between the driver side coupling part 33 and the vehicle body side coupling part 32 in the flow regulating cloth main body 31. These gas outlets 34 are regions to allow the expansion gas G discharged from the inflator 8 to flow the inside of the bag main body 20. These gas outlets 34 direct the flowing direction of the expansion gas into the bag main body 20 to longitudinal directions that are symmetric centering on this gas inlet 22. Specifically, the gas outlets 34 are provided at two places to the front and rear of the opening 32a along the circumference portion of the opening 32a, respectively. The breakaway lines 35 are arranged so as to connect the gas outlets 34. Each breakaway line 35 is configured with perforated cuts formed on the base cloth composing the flow regulating main body 31. These breakaway lines 35 are ruptured when the inner pressure of the bag main body 20 reaches a certain pressure (10 to 20 kPa). Then, upon rupture of the breakaway lines 35, the driver side coupling part 33 and the vehicle body side coupling part 32 in the flow regulating cloth main body 31 are separated. As a result, the coupling between the driver side wall 24 and the adjacent region by the gas inlet 22 of the vehicle body side wall 21 is broken.

The tether parts 36 are formed in a band-like shape and they are elongated from the circumference portion of the flow regulating cloth main body 31 to the right and left opposite sides. These tether parts 36 control the interval from the gas inlet 22 to the driver side wall 24 upon completion of the expansion of the airbag 19 so as to control the expanding shape of the bag main body 20. The end portions 36a of the tether parts 36 are sewed to end portions 28d of coupling portions 28c to be arranged on the reinforcing cloth 28B.

Then, it is possible to manufacture the airbag 19 according to the present embodiment as follows. At first, the flow regulating cloth 30 is sewed in advance on the region of the coupling part 33 in the driver side base cloth 27. In addition, on the circumference portion around the gas inlet 22 of the vehicle body side base cloth 26, the reinforcing cloths 28A, 28B, 28C, and 28D are sewed. Then, placing the driver side base cloth 27 and the vehicle body side base cloth 26, respectively, so that their outer surface sides are opposed to each other, and sewing their outer circumferences to each other by using a suture thread, it is possible to form the bag main body 20. After that, the bag main body 20 is inverted by pulling through the gas inlet 22 so that the seams do not appear on the outer surface of the airbag 19. After the inversion operation, the end portions 28d of the coupling portions 28c to be formed on the reinforcing cloth 28D and the end portions 36a of the tether parts 36 to be formed on the flow regulating cloth 30 are pulled out from the gas inlet 22. Sewing the pulled end portions 28d and 36a to each other, it is possible to manufacture the airbag 19.

Then, by using the airbag 19 that is manufactured as described above, the airbag system M is assembled. At first, arranging the retainer 6 between the driver side wall 24 and the flow regulating cloth main body 31 in the airbag 19, each bolt 6a is projected from the mounting hole 23. After that, the airbag 19 is folded. In the present embodiment, the airbag 19 is folded through the first and second steps.

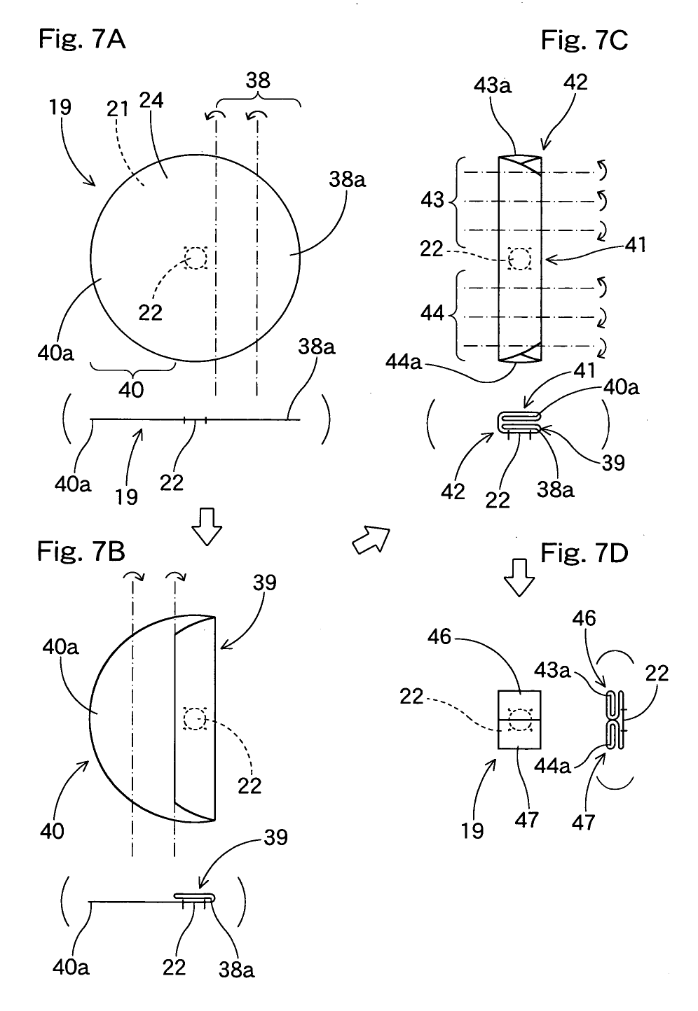

In the first step, the airbag 19 is unfolded flatly with the driver side wall 24 and the vehicle body side wall 21 facing each other, and then the airbag 19 is folded so as to reduce the width in the transverse direction. Specifically, the airbag 19 is folded along folding lines in roughly the longitudinal direction so as to bring the regions at the right and left opposite edges close to the gas inlet 22. At first, as shown in FIGS. 7A and 7B, a right side region (namely, a vehicle exterior region, when the system is mounted in the vehicle) 38 located to the right side of the gas inlet 22 is roll-folded along the folding lines in the longitudinal direction from the outer circumference portion 38a toward the driver side wall 24. In other words, the right side region 38 is folded internally rolled. Folding this region so as to be superimposed above the gas inlet 22, a folded portion 39 is formed. After that, as shown in FIGS. 7B and 7C, a folded portion 41 is formed in such a manner that a left side region (namely, a vehicle interior region, when the system is mounted in the vehicle) 40 located to the left side of the gas inlet 22 is roll-folded along the folding lines in the longitudinal direction from the outer circumference portion 40a toward the driver side wall 24. In other words, the left side region 40 is folded internally rolled. Then, folding this folded portion 41 so as to be superimposed above the folded portion 39, the first step is completed.

Subsequently, in the second step, the airbag 19 is folded so as to reduce the width in the longitudinal direction of the first folded body 42 that was folded in the first step. Specifically, the first folded body 42 is folded along folding lines in the approximate transverse direction so as to bring the regions at the rear and front edges close to the gas inlet 22. As shown in FIGS. 7C and 7D, the front side region 43 located to the front side of the gas inlet 22 in the first folded body 42 is roll-folded along the folded lines in the transverse direction from the outer circumference portion 43a toward the vehicle body side wall 21, thus forming folded portion 46. In other words, the front side region 43 is folded externally rolled. In the same way, a rear side region 44 located to the rear side of the gas inlet 22 in the first folded body 42 is roll-folded along the folded lines in the transverse direction from the outer circumference portion 44a toward the vehicle body side wall 21, thus forming folded portion 47. When these two folded portions 46 and 47 are arranged in parallel horizontally to be superimposed above the gas inlet 22, the second step is completed. This completes folding of the airbag 19.

Subsequently, housing of the folded airbag 19 into the case 10 will be described below. At first, the airbag 19 is put on the holder plate 12. In this case, each bolt 6a of the retainer 6 projecting from the folded airbag 19 is passed through each mounting hole 12b to be formed on the holder plate 12 of the bag holder 11.

After that, the pad 15 is placed over the airbag 19 and fastened on the holder plate 12. Further, the back-up plate 13 is arranged below the holder plate 12. Then, the side wall part 17 of the pad 15 is clipped between the holder plate 12 and the back-up plate 13 so that the pad 15 is held by the bag holder 11. In this case, each bolt 6a of the retainer 6 is passed through each mounting hole 13b that is formed on the back-up plate 13.

Then, the main body 8a of the inflator 8 is inserted into the insertion holes 12a and 13a of the bag holder 11, the gas inlet 22, and the opening 32a from its lower side. At this time, each bolt 6a of the retainer 6 is projected downward from each insertion hole 8d formed on the flange part 8c of the inflator 8. After that, if the nut 7 is screwed to each bolt 6a, the airbag 19, the bag holder 11, and the inflator 8 are integrally assembled. Thus, the assembly of the airbag system M is completed.

After that, with the core metal 2 of the boss part B of the steering wheel main body 1 fastened to the steering shaft SS of the vehicle, by using a bracket (not illustrated) of the bag holder 11, the airbag system M is coupled to the core metal 2. In this way, the airbag system M can be attached to the steering wheel W. If the steering wheel W is mounted on the vehicle and the expansion gas is discharged from the gas discharge ports 8b of the inflator main body 8a, the folded airbag 19 may expand greatly by rupturing the pad 15 at the predetermined position.

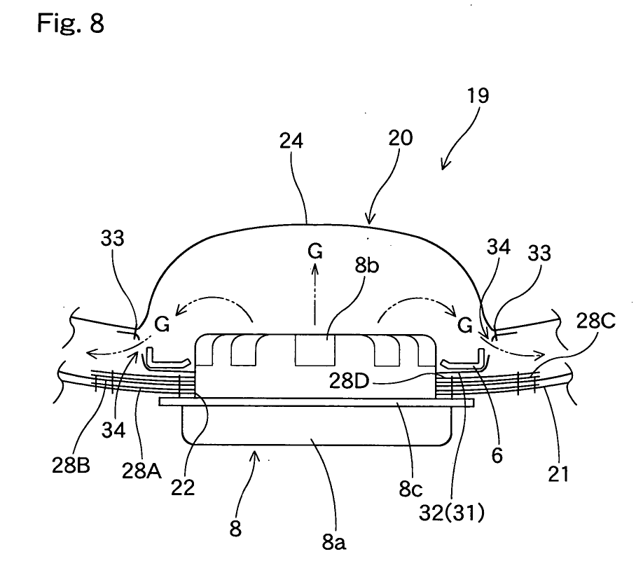

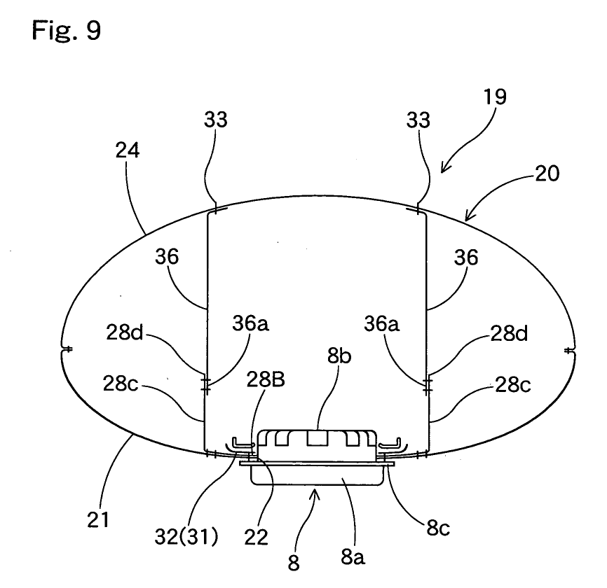

According to the present embodiment, in the beginning of the operation of the inflator 8, the expansion gas G discharged from the gas discharge ports 8b of the inflator main body 8a, as shown in FIG. 8, fills the space between the driver side wall 24 and the flow regulating cloth main body 31. After that, the expansion gas G may flow into the bag main body 20 with the flowing directed to the longitudinal direction from the gas outlets 34 formed in the flow regulating cloth main body 31. After that, further, when the expansion gas G flows into the bag main body 20 and the inner pressure of the bag main body 20 reaches a certain pressure, the breakaway lines 35 are ruptured, formed on the flow regulating cloth main body 31. As a result, the coupling between the driver side wall 24 and the vehicle body side wall 21 at the vicinity of the gas inlet 22 is broken. Then, the bag main body 20 has completely expanded, as shown in FIG. 9. As shown by a chain double-dashed line in FIG. 10, upon completion of the expansion, the bag main body 20 is arranged so as to cover the upper side of the entire steering wheel W.

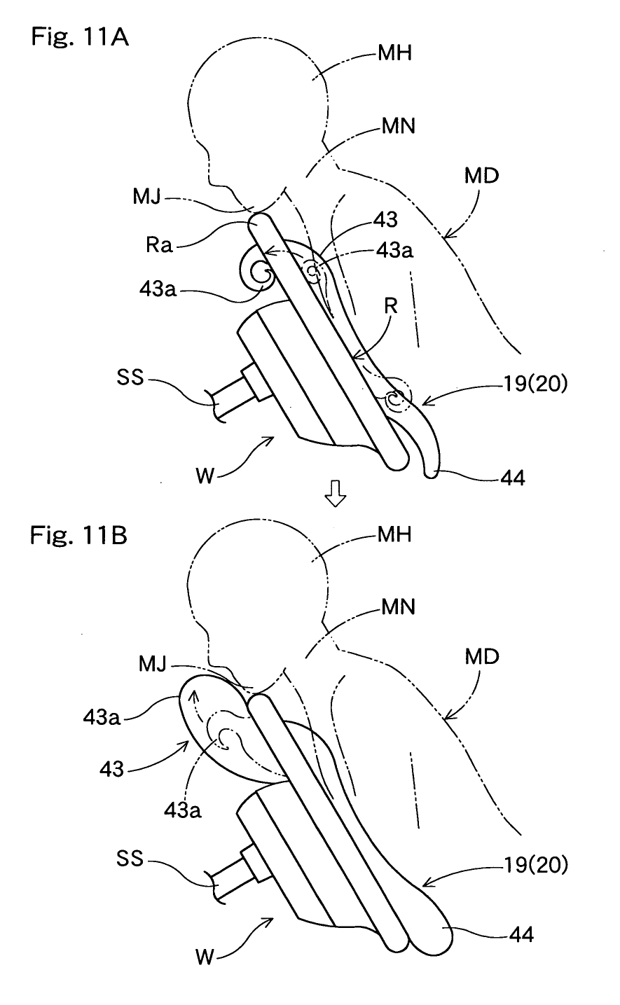

Then, according to the airbag system M of the present embodiment, when the airbag 19 is unfolded and expands, if the driver MD's head MH is brought close to the front side region of the ring part R of the steering wheel W, the airbag 19 may be unfolded and expand as follows. At the early stage of the expansion, folded portions 46 and 47 of the airbag 19 folded in the second step unfold. In the airbag system M according to the embodiment, in the second step, the front side region 43 located to the front side of the gas inlet 22 in the airbag 19 is roll-folded from the outer circumference portion (the front edge portion) 43a toward the vehicle body side wall 21. Namely, the front side region 43 is folded externally rolled. Therefore, as shown in FIG. 11A, this front side region 43 is unfolded so as to enter space A (refer to FIG. 1) for viewing the meter formed between the boss part B and the front region Ra of the ring part R, thereby interfering with the driver MD. Then, as shown in FIG. 11B, the unfolded front side region 43 can be held down by the region Ra to expand at the front of the ring part R. As a result, the front side region 43 is prevented from expanding so as to project toward the head MH of the driver MD.

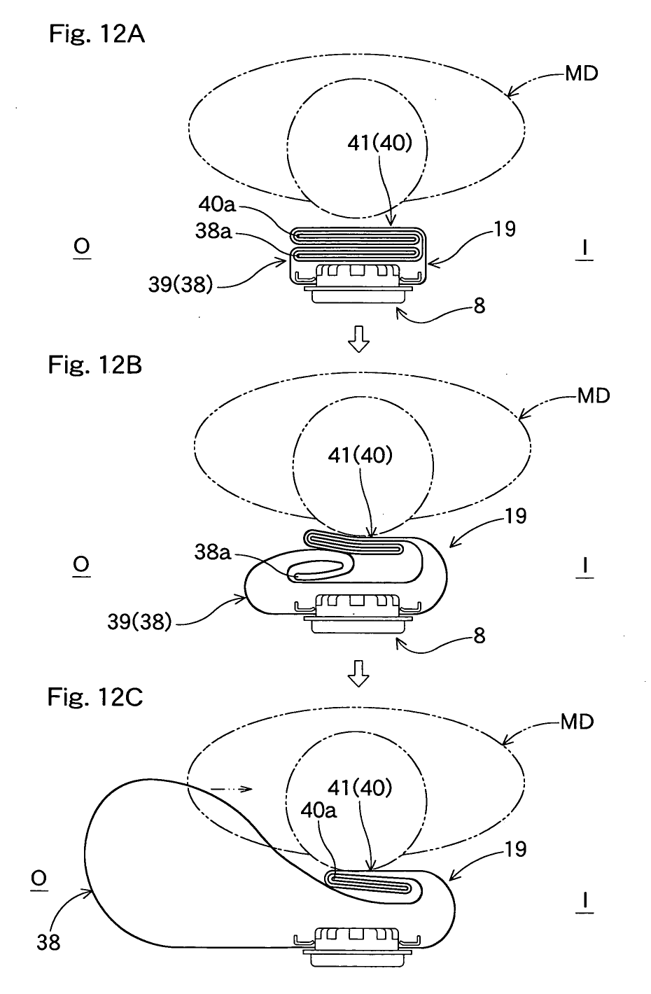

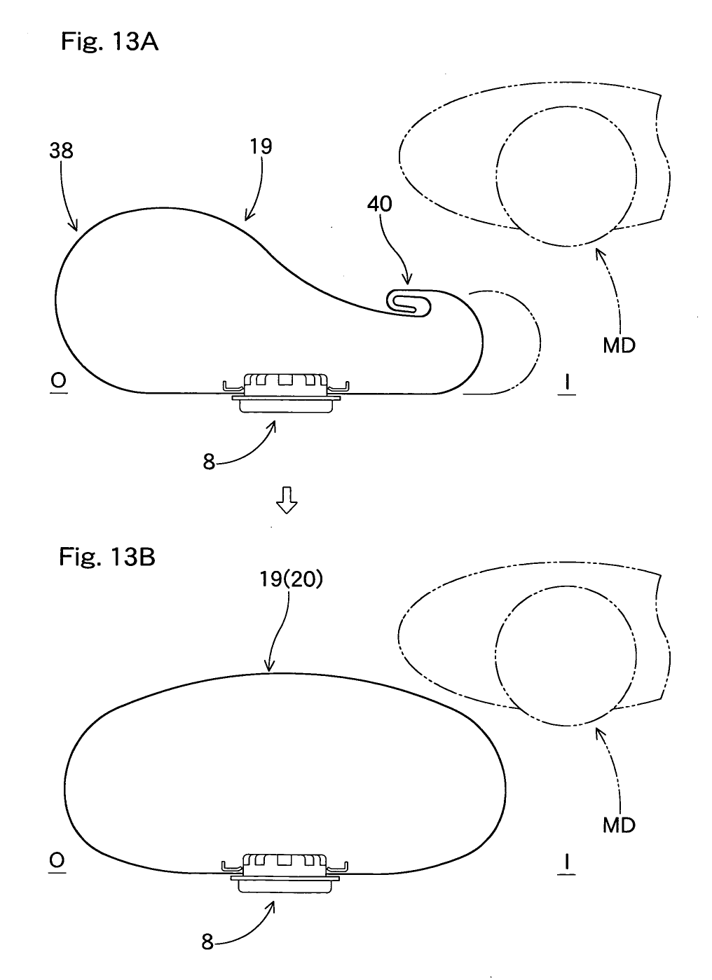

Then, substantially at the same time as unfolding of the folded portions 46 and 47 folded in the second step, the airbag 19 may be unfolded and expand so as to unfold the folded portions 39 and 41 folded in the first step. In the airbag system M according to the present embodiment, the folded portion 41 located at the top (formerly the left side region 40) is roll-folded from the outer circumference portion 40a toward the driver side wall 24. Namely, the left side region 40 is folded internally rolled. Therefore, when the airbag 19 is unfolded and expands, if this folded portion 41 contacts the driver MD near the steering wheel W, this folded portion 41 is folded over itself toward the driver side wall 24, so that the release of the folding of the internally rolled portion 41 is prevented due to the friction force generated by the interference with the driver MD. Then, as shown in FIGS. 12B and 12C, this portion 41 does not expand so as to unfold but rather the folded portion 39 (the right side region 38) arranged below the folded portion 41 expands with the expansion gas flowing therein while unfolding. In other words, in the airbag system M, when driver MD is near the steering wheel W upon release of the folding of the folded portions 39 and 41 that are folded in the first step, at first, only the right side region 38 (the vehicle exterior side O) of the gas inlet 22 may greatly expand with the expansion gas flowing therein. After that, in accordance with the expansion of this region 38, the driver MD near the steering wheel W is pushed to the left side (the vehicle interior side I). As a result, as shown in FIG. 13A, the driver MD moves to the left side (the vehicle interior side I) so as to remove the driver MD from the expansion area of the airbag 19. Further, after the driver MD moves, the folded portion 41 is unfolded by the flow of the expansion gas therein. Then, the front side region 43, whose upper side is suppressed by the front side region Ra of the ring part R, may also project to the upper side of the ring part R in accordance with the expansion of other regions. As a result, as shown by the chain double-dashed line in FIG. 10, the airbag 19 is completely expanded thickly so as to cover the upper side of the entire steering wheel W, the same as the case that the driver MD is not near the steering wheel W.

In other words, according to the airbag system M of the present embodiment, when the driver MD is near the steering wheel W, the airbag 19 may expand as follows. At first, in the early stage of the expansion, the airbag 19 is prevented from projecting to the driver MD as much as possible because the front side region 43 is caught on the front side region Ra of the ring part R. In this state that the projection to the driver MD is prevented, the airbag 19 may move the driver MD pushing to the left side (the vehicle interior side I) by expanding the right side region 38 located toward the vehicle exterior side O so as to remove the driver MD from the greatest expansion area of the airbag 19. Then, after the driver MD moves away from the greatest expansion area of the airbag 19, the airbag 19 may complete its upward expansion and cover the upper side of the entire steering wheel W including the front side region 43. Therefore, the airbag 19 can expand without applying strong pushing force due to upward expansion to the driver MD near the steering wheel. As a result, it is possible to prevent the driver MD from being strongly pushed for example with the airbag 19 between the driver's neck MN and the driver's jaw MJ (refer to FIG. 11) so as to fix the jaw MJ.

Accordingly, in the airbag system M of the present embodiment, it is possible to unfold and expand the airbag 19 with reduced pushing force applied to the driver MD in the case that the driver MD is near the steering wheel W.

In addition, in the airbag system M of the present embodiment, in the early stage of the expansion of the airbag 19, the vicinity of the center of the driver side wall 24 and the vicinity of the gas inlet 22 are coupled by the flow regulating cloth 30. Therefore, it is possible to limit the upward expansion of the airbag in the vicinity of the center of the airbag 19 in the early stage of the expansion. In other words, in the airbag system M of the present embodiment, in the early stage of the expansion of the airbag 19, it is possible to expand thickly the right side region 38 first, preventing the vicinity of the center from expanding thickly. As a result, the airbag 19 can expand in its right side region 38 thickly with rapidity and the right side region 38 can move the driver MD to the left side (the vehicle interior side I) while the vicinity of the center of the airbag 19 is suppressed from contacting to the driver MD. In addition, in the airbag system M of the present embodiment, in the early stage of the expansion of the airbag 19, the expansion gas may flow through the gas outlets 34 formed in the flow regulating cloth 30 into the bag main body 20 along the longitudinal direction. Therefore, in the early stage of the expansion of the airbag 19, it is possible to immediately unfold the front side region 43 of the gas inlet 22 to enter the space A for viewing a meter. This makes it possible to suppress expansion of this front side region 43 which pushes the head MH of the driver MD as much as possible.

In addition, the airbag system M of the present embodiment is configured so that in the early stage of the expansion of the airbag 19, the folded portion 39 (formerly the right side region 38) which does not initially contact the driver MD may be unfolded and expand so as to move the driver MD. Therefore, this is preferable because it is possible to prevent the airbag 19 from expanding while scraping with the driver MD who contacts the airbag 19. In the meantime, according to the airbag system M of the present embodiment, the right side region 38 is also roll-folded internally from the outer circumference portion 38a toward the driver side wall 24. However, the folding shape of the right side region 38 is not limited to this. For example, the right side region 38 may be roll-folded externally from the outer circumference portion 38a toward the vehicle body side wall 21. In addition, the right side region 38 may be folded by accordion folding or the like, thus bringing the outer circumference portion 38a close to the side of the gas inlet 22.

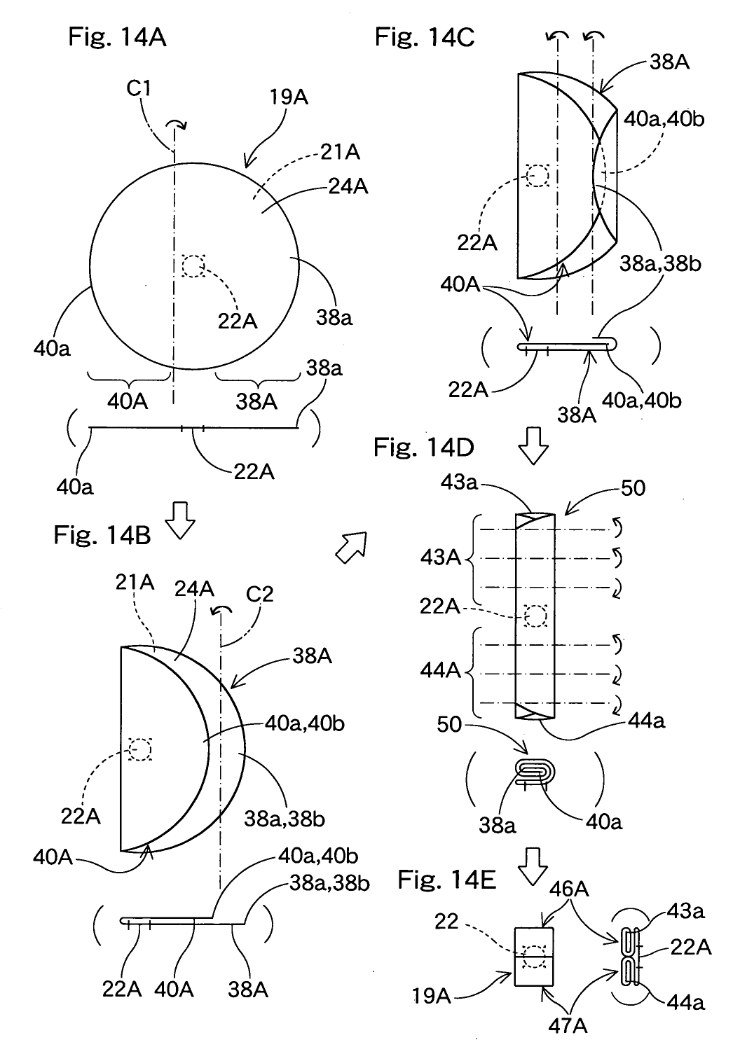

In addition, an airbag 19A having the same configuration as the above-described airbag 19 may be folded as shown in FIGS. 14A to 14E. The airbag 19A is different from the airbag 19 of the above-described airbag system M only in its folded shape and except for this, the airbag 19A is the same as the airbag 19. Therefore, with respect to the same member, “A” is given to the end of the same reference numeral.

Also in the folding shown in FIGS. 14A to 14E, the airbag 19A is folded through the first and second steps. At first, the airbag 19A is unfolded flatly with the driver side wall 24A and the vehicle body side wall 21A superimposed. And then, in the first step, as shown in FIGS. 14A and 14B, a left side region (a vehicle interior region, when the airbag 19A is mounted in the vehicle) 40A located at the left side of the gas inlet 22A is folded over the driver side wall 24A to the right side region (a vehicle exterior region, when the airbag 19A is mounted in the vehicle) 38A along a folding line C1 in the longitudinal direction in the vicinity of the gas inlet 22A. In this case, the outer circumference portion 40a of the left side region 40A has been brought close to the outer circumference portion 38a of the right side region 38A. After that, as shown in FIGS. 14B and 14C, the right side region 38A is folded along a folded line C2 in the longitudinal direction in the vicinity of the outer circumference portion 38a. In this case, the furthest edge portion 38b of the outer circumference portion 38a is arranged to be superimposed on the upper part of the furthest edge portion 40b at the outer circumference portion 40a of the left side region 40A. In other words, at the furthest edge portion 40b of the left side region 40A, the upper and lower sides and the leading end side are wrapped by the outer circumference portion 38a of the right side region 38A. After that, the right side region 38A is folded along a folded line in the longitudinal direction together with the left side region 40A. Specifically, the right side region 38A is roll-folded internally from the folded back side of the outer circumference portion 38a toward the driver side wall 24A. Then, the rolled region is folded again so as to be superimposed above the gas inlet 22A to form a folded portion 50 and complete the first step (refer to FIG. 14D). Upon the completion of this first step (resulting in first folded body 42A), in the outer circumference portion 40a of the left side region 40A, the upper and lower sides and the leading end side have been covered by the right side region 38A. Specifically, the outer circumference portion 38a of the right side region 38A is arranged so as to cover the upper side of the outer circumference portion 40a of the left side region 40A and portion of the right side region 38A between the outer circumference portion 38a and the center is arranged so as to cover the portion of the left side region 40A from the leading end to the lower side of the outer circumference portion 40a side (refer to FIG. 14D).

Then, in the second step, the first folded body 42A is folded the same as the second step in the above-described folding. The front side region 43A located at the front side of the gas inlet 22A in the first folded body 42A is roll-folded externally from the outer circumference portion 43a toward the vehicle body side wall 21A, a folded portion 46A is formed. In the same way, the rear side region 44A in the first folded body 42A is roll-folded externally from the outer circumference portion 44a toward the vehicle body side wall 21A, a folded portion 47A is formed (refer to FIGS. 14D and 14E).

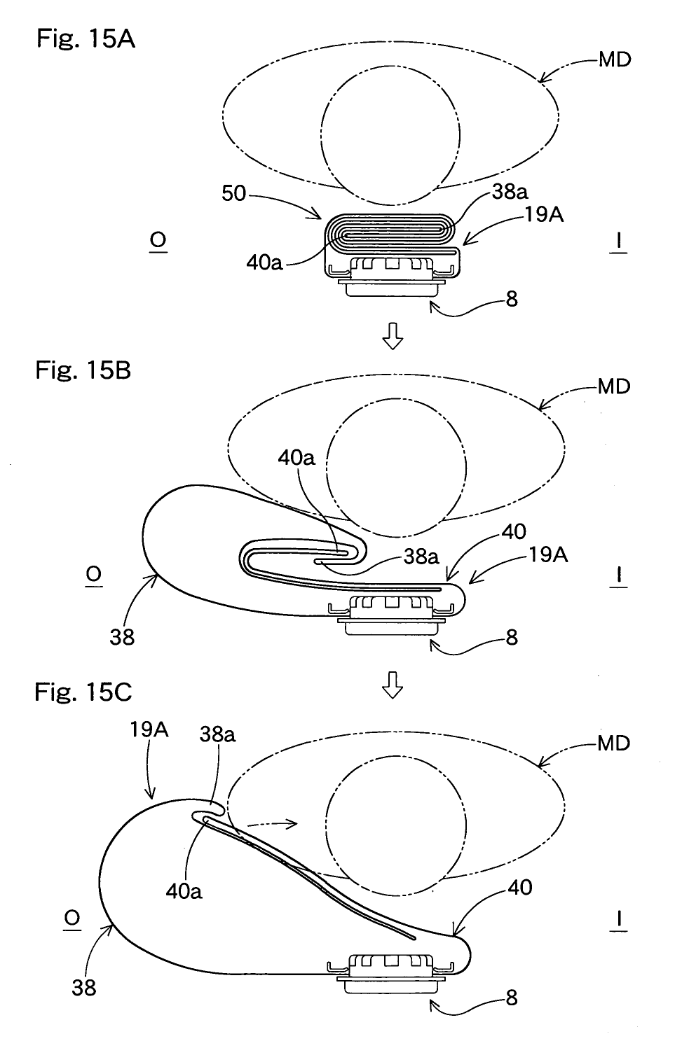

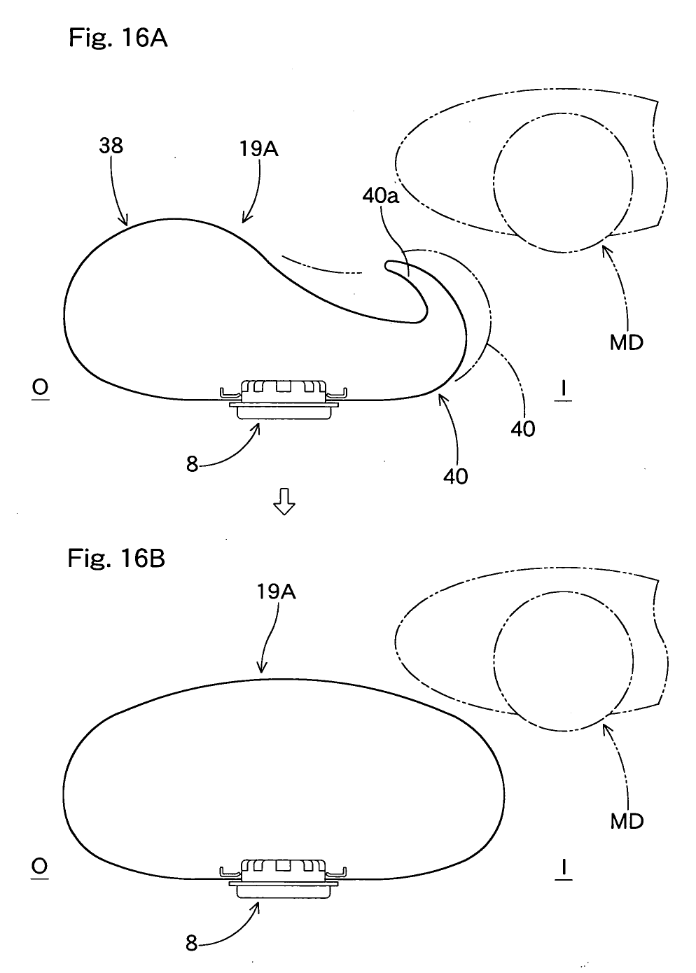

Also in the case of using the airbag 19A folded in this way, upon unfolding the folding in the first step, as shown in FIGS. 15B and 15C, the unfolding of the left side region 40A located vehicle interior side I is prevented, and only the folding of the right side region 38A located vehicle exterior side O is unfolded by expansion due to the expansion gas flowing therein. Particularly, according to the airbag 19A of the present embodiment, the left side region 40A and the right side region 38A are folded superimposed each other, so that the edge portion 40b at the outer circumference portion 40a of the left side region 40A is wrapped at its upper and lower sides and leading end side by the right side region 38A. Therefore, the folding of the left side region 40A is not released until the folding in the vicinity of the outer circumference portion 38a in the right side region 38A is released. As a result, it is possible to reliably expand the right side region 38A located vehicle exterior side O ahead of the left side region 40A located vehicle interior side I. Therefore, in accordance with the expansion of the right side region 38A located vehicle exterior side O by flow of the expansion gas, the driver MD near the steering wheel W is pushed to the left side (vehicle interior side I) and as shown in FIG. 16A. The driver MD moves to the left side (vehicle interior side I) so that the driver MD is removed from the greatest expansion area of the airbag 19A. Then, if the folding of the right side region 38A is completely released after the driver MD moves, the left side region 40A may expand with flow of the expansion gas therein. Further, the front side region 43A also projects above the ring part R in accordance with the expansion of the other regions. As a result, the airbag 19A may complete its upward thickly expansion and cover the upper side of the steering wheel W.

In other words, even if the airbag 19A folded as described above is used, in the case that the driver MD is near the steering wheel W, it is possible to expand the airbag 19 as follows. At the early stage of expansion, the airbag 19A is prevented from projecting to the driver MD as much as possible, because the front side region 43A is caught on the front side region Ra of the ring part R. Then, maintaining the state where the projection to the driver MD is prevented as much as possible, the airbag 19 pushes the driver MD to the left side (vehicle interior side I) so as to remove the driver MD from the greatest expansion area of the airbag 19A by expanding the right side region 38A located vehicle exterior side O. Then, after the driver MD moves away from the greatest expansion area of the gas inlet 22A, the upward thickly expansion of the whole airbag 19A is completed so as to cover the upper surface of the entire steering wheel W including the front side region 43A. Therefore, the airbag 19A can expand without applying the force generated by the upward expansion to the driver MD. As a result, it is possible to prevent the driver from being strongly pressed, for example with the airbag 19A between the driver's neck MN and the driver's jaw MJ so as to fix the jaw MJ.

Accordingly, as described above, even if the folded airbag 19A is used as described above, the airbag 19A can be unfolded and expand with reduced pressure applied to the driver MD near the steering wheel W.

Moreover, in the first process, in the airbag 19A, the furthest edge portion 40b at the outer circumference portion 40a of the left side region 40A is folded so as to be suppressed by the furthest edge portion 38b of the outer circumference portion 38a of the right side region 38A. Therefore, when the airbag 19A is unfolded and expands, the unfolding and expansion of the left side region 40A located vehicle interior side I is prevented as much as possible. Thus, conversely, most of the right side region 38A at the vehicle exterior side O is expanded before the furthest edge portion 38b of the outer circumference portion 38a expands. As a result, the driver MD near the steering wheel W is pushed far to the left side (vehicle interior side I), which is preferable.

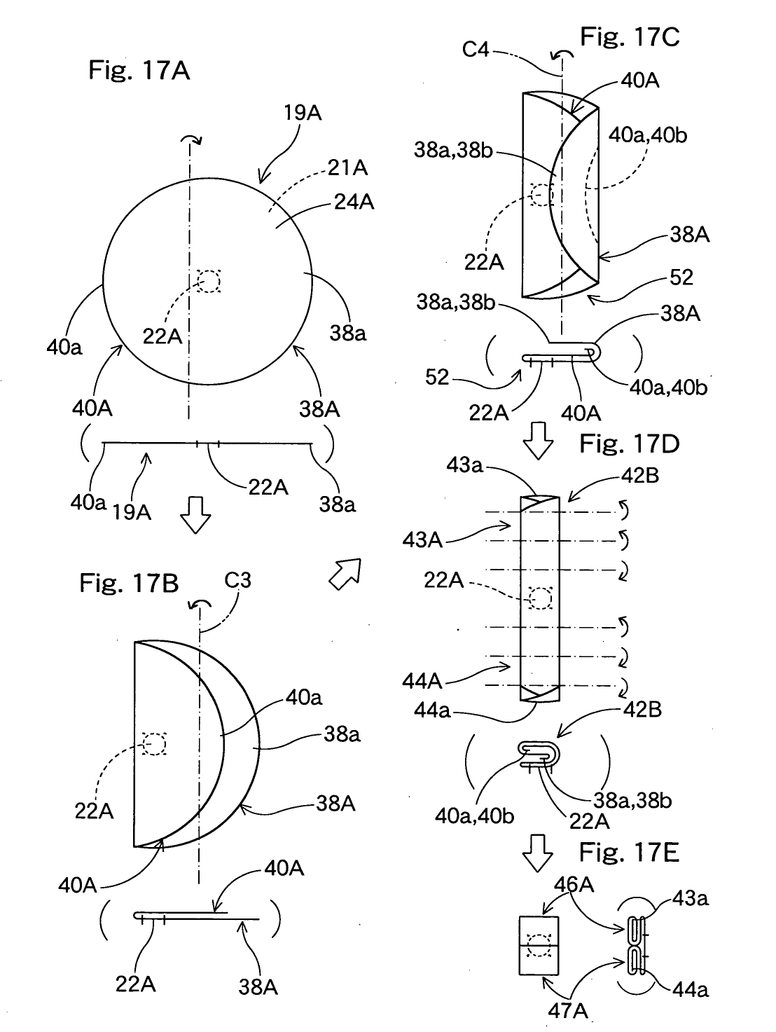

If these points are not considered important, the airbag 19A may be folded as shown in FIGS. 17A to 17E. In the folding shown in FIGS. 17A to 17E, in the first step, the left side region 40A is folded over the driver side wall 24A of the right side region 38A along the folding line C1 so as to bring the outer circumference portion 40a close to the outer circumference portion 38a of the right side region 38A. Then, from this state, the right side region 38A is folded back together with the left side region 40A along a folding line C3 in the longitudinal direction to the vicinity of the center in the transverse direction so as to bring the outer circumference portion 38a close to the gas inlet 22A. Moreover, an folded airbag 52 in this folded state is folded so as to be folded back along a folding line C4 in the longitudinal direction in the vicinity of the center in the transverse direction. In the folded body 42B through such a first step, as shown in FIG. 17D, the outer circumference portion 40a of the left side region 40A (namely, the furthest edge portion 40b) is configured so that it cannot be suppressed from above by the outer circumference portion 38a in the right side region 38A (namely, the furthest edge portion 38b). However, in the outer circumference portion 40a of the left side region 40A (namely, the furthest edge portion 40b), the furthest end side and the upper and lower sides are wrapped by the area between the gas inlet 22A and the furthest edge portion 38b in the right side region 38A so that the upper and lower walls are wrapped, with other regions in the left side region 40A (namely, the region from the gas inlet 22A to the furthest edge portion 40b) interposed. Therefore, it is possible to expand the right side region 38A with certainty ahead of the left side region 40A.

In the meantime, according to the present embodiment, in the second step, the airbags 19 and 19A are configured so that the rear side regions 44 and 44A located at rear side of the gas inlets 22 and 22A are roll-folded externally from the outer circumference portion 44a toward the vehicle body side walls 21 and 21A, the same as the front side regions 43 and 43A. However, the folding method of the rear side regions 44 and 44A is not limited to this. For example, the rear side regions 44 and 44A may be folded by accordion folding or the like.

In addition, according to the embodiment, the airbags 19 and 19A are mounted on a vehicle with right-hand drive and each of them is folded so as to move the driver MD to the left side that is made the vehicle interior side I. When mounting the airbag system of the present invention on a vehicle with left-hand drive, the vehicle interior side I is the right side of the driver's seat. When folding the airbags so as to move the driver to the right side which is the vehicle interior side I, the airbag is folded with right and left reversed as compared to the embodiment.

In the meantime, according to the embodiment, the airbags 19 and 19A are folded so as to move the driver MD to the vehicle interior side I. It is a matter of course that the airbags 19 and 19A may be folded so as to be capable of moving the driver MD to the right side which is the vehicle exterior side O while reversing right and left.

What is claimed is:

1. An airbag system for a steering wheel that is mounted on a steering wheel,
wherein the steering wheel comprises a ring part, which is formed in an approximate annular shape and is held upon operation of the steering wheel; a boss part, which is arranged on the center of the steering wheel and is coupled to a steering shaft; and a spoke part, which is arranged so as to connect said ring part with said boss part;
said spoke part is provided so as to be able to secure a space for viewing a meter, formed at the inner circumferential side of said ring part;
said airbag system for the steering wheel comprises an airbag that is folded and housed in said boss part, said airbag can be unfolded and expanded by allowing the expansion gas to flow therein, so as to be able to protect a driver and cover the upper side of said steering wheel; and
said airbag is configured in such a manner that the periphery of a roughly circular vehicle body side wall, which is arranged toward the steering wheel upon completion of expansion of the airbag and has a gas inlet for admitting the flow of the expansion gas in the vicinity of the center thereof, and the periphery of a driver side wall, which is arranged toward the driver upon completion of expansion and whose outer shape is approximately the same as that of said vehicle body side wall, are coupled to each other;
wherein said airbag is folded and housed through at least two steps, namely, a first step and a second step, after said airbag is unfolded flatly with said driver side wall and said vehicle body side wall superimposed;
in said first step, in order to reduce the width in the transverse direction of said airbag, the regions at the opposite edges in the transverse direction are folded along folding lines in roughly the longitudinal direction, so that the transverse edges are brought close to said gas inlet; and
in said second step, in order to reduce the width in the longitudinal direction of said airbag that is folded in said first step, the regions at the opposite edges in the longitudinal direction are folded along folding lines in roughly the transverse direction, respectively, so that the longitudinal edges are brought close to said gas inlet;
wherein, according to said first step, after said airbag is unfolded flatly with said driver side wall and said vehicle body side wall superimposed, one of the region in the transverse direction of said gas inlet is folded so as to reduce the width in the transverse direction and is put on the upper side of said gas inlet; and then, the other region in the transverse direction is roll-folded from the outer circumference edge in the transverse direction toward said driver side wall and be superimposed above said folded region at the one side; and
according to said second step, said airbag is folded in such a manner that, when bringing the regions to the front and the rear of said gas inlet close to said gas inlet, at least the front side region located to the front side of said gas inlet is roll-folded from its front edge toward said vehicle body side wall.

2. The airbag system for a steering wheel according to claim 1, wherein, according to said first step, a vehicle exterior region in the transverse direction of said gas inlet is folded so as to reduce the width in the transverse direction and is put on the upper side of said gas inlet; and then, a vehicle interior region in the transverse direction is roll-folded from the outer circumference portion in the transverse direction toward said driver side wall and is superimposed above said folded vehicle exterior region.

3. An airbag system for a steering wheel that is mounted on a steering wheel,
wherein the steering wheel comprises a ring part, which is formed in an approximate annular shape and is held upon operation of the steering wheel; a boss part, which is arranged on a center of the steering wheel and is coupled to a steering shaft; and a spoke part, which is arranged so as to connect said ring part with said boss part;
said spoke part is provided so as to be able to secure a space for viewing a meter, formed at the inner circumferential side of said ring part;
said airbag system for the steering wheel comprises an airbag that is folded and housed in said boss part, said airbag can be unfolded and expanded by allowing the expansion gas to flow therein, so as to protect a driver and cover the upper side of said steering wheel; and
said airbag is configured in such a manner that the periphery of a roughly circular vehicle body side wall, which is arranged contacting the steering wheel upon completion of expansion of the airbag and has a gas inlet for allowing the expansion gas to flow in the vicinity of the center thereof, and the periphery of the driver side wall, which is arranged toward the driver upon completion of expansion and whose outer shape is approximately the same as that of said vehicle body side wall, are coupled to each other;
wherein said airbag is folded and housed through at least two steps, namely, a first step and a second step, after said airbag is unfolded flatly with said driver side wall and said vehicle body side wall are superimposed;
in said first step, in order to reduce the width in the transverse direction of said airbag, the regions at the opposite edges in the transverse direction are folded along folding lines roughly in the longitudinal direction, respectively, so that the transverse edges are brought close to said gas inlet; and
in said second step, in order to reduce the width in the longitudinal direction of said airbag that is folded in said first step, the regions at the opposite edges in the longitudinal direction are folded along folding lines roughly in the transverse direction, so that the longitudinal edges are brought close to said gas inlet;
wherein, according to said first step, after said airbag is unfolded flatly with said driver side wall and said vehicle body side wall are superimposed, one of the region in the transverse direction of said gas inlet is folded above said driver side wall of the other region in the transverse direction along a folding line roughly in the longitudinal direction at a position in the vicinity of said gas inlet so as to bring the outer circumference of the one of the region toward the outer circumference of the other region; and then, at the furthest edge portion of the outer circumference in the transverse direction at said one of the region, the upper and lower sides and the furthest edge side are wrapped by the other region, the said other region is folded so as to bring its outer circumference side in the transverse direction close to said gas inlet with said one of the region superimposed on said other region, and said other region at the other side is put on the upper side of said gas inlet; and
according to said second step, when bringing the regions to the front and the rear of said gas inlet close to said gas inlet side, at least the front side region of said gas inlet is roll-folded from its front edge toward said vehicle body side wall.

4. The airbag system for a steering wheel according to claim 3, wherein, according to said first step, said airbag is folded in such a manner that, after folding the one of the region in the transverse direction of said gas inlet over the driver side wall of the other region in the transverse direction,
the outer circumference region in the transverse direction of the other region is folded back so as to be superimposed above the outer circumference region in the transverse direction of the one of the region and so as to wrap the furthest edge portion at the outer circumference in the transverse direction of the one of the region by the outer circumference region in the transverse direction of said other region; and then, with said one of the region superimposed on said other region, said other region is folded to put on the upper side of said gas inlet by roll-folding from said folded back edge of said other region toward said driver side wall.

5. The airbag system for a steering wheel according to claim 3, wherein, according to said first step, a vehicle interior region in the transverse direction of the gas inlet is folded above the driver side wall of a vehicle exterior region in the transverse direction along a folding line in the roughly longitudinal direction in the vicinity of the gas inlet so as to bring its outer circumference toward the outer circumference of the vehicle exterior region; and then, the upper and lower sides and the furthest edge side of the furthest edge portion of the outer circumference in the transverse direction of the vehicle interior region are wrapped by the vehicle exterior region; and with the vehicle interior region superimposed on the vehicle exterior region, the vehicle exterior region is folded so as to bring its outer circumference in the transverse direction close to the gas inlet and the vehicle exterior region is put on the upper side of the gas inlet.
